(19) United States
(12) Patent Application Publication
(10) Pub. No.: US 2005/0079310 A1
(43) Pub. Date: Apr. 14, 2005

(54) Folded roll product and method and apparatus for making and using the same

(76) Inventor: Patrick C. St. Germain, Iron River, WI (US)

Correspondence Address: OLSON & HIERL, LTD., 36th Floor, 20 North Wacker Drive, Chicago, IL, 60606, US

(21) Appl. No.: 10/682,444

(22) Filed: Oct. 9, 2003

(51) Int. Cl. G09F 3/00

(52) U.S. Cl. 428/43; 428/124

(57) ABSTRACT

A roll of folded sheet material where the sheet of material includes at least one longitudinal fold line and at least one fold made about the longitudinal fold line. The roll is created by feeding the sheet of material through a folding board and then winding the same onto an accumulator roll. The rolls are adapted to be transferred to dispensers adapted to feed the sheets of material dispensed therefrom through an interfolder for creating an interfolded web of sheet material.

### FIELD OF THE INVENTION

This invention relates to a roll product and, more particularly, to a roll product comprising folded sheet material and the method and apparatus for making and using the same.

### BACKGROUND OF THE INVENTION

Interfolding of sheet material such as, for example, the formation of interfolded sheets of facial tissue or the like is a well known expedient. Interfolding involves the steps of first folding respective separate sheets of material along selected longitudinal fold lines and then interfolding such respective separate longitudinally folded sheets of material together so as to provide an interfolded web of sheet material which is then formed into stacks of interfolded sheets and packaged into consumer boxes.

In order to provide more compact packaging of interfolded sheet material having a wide variety of fold configurations, it would be desirable to provide a finished roll of interfolded sheet material from which individual sheets can be dispensed. The present invention satisfies this desire.

### SUMMARY OF THE INVENTION

The present invention is directed to a roll product of dispensable sheet material in the form of an elongate continuous sheet that includes at least one longitudinally extending fold line and at least one fold made transverse to the longitudinally extending fold line. The roll product can be wet or dry, as desired, and may include interfolded sheet material as well as lines of perforation or weakening in the sheet material.

The apparatus for making the roll product of the present invention includes a folding board to which elongate sheet of material is fed from a supply roll to produce at least one longitudinally extending fold line and at least one transverse fold and an accumulator roll downstream of the folding board onto which folded sheet of material is wound while maintaining its folded orientation.

A perforator may be provided between the folding board and the accumulator roll for forming a plurality of spaced-apart transversely extending lines of weakening or perforation.

In another aspect of the present invention, the folded sheets of material may be interfolded in a separate operation by providing at least two folded sheet material dispensers each containing a roll of folded sheet material and an interfolder through which the folded sheet material from each roll is fed for interfolding thereby forming a web of folded as well as interfolded sheets of material.

### BRIEF DESCRIPTION OF THE DRAWINGS

In the drawings,

FIG. 1 is a perspective view of a finished roll product of the folded sheet material product of the present invention;

FIG. 2 is a schematic front elevational view of the apparatus for forming the roll sheet product of FIG. 1;

FIG. 3 is a schematic diagram of various fold configurations of the sheet material product of the present invention;

FIG. 4 is a schematic front elevational view depicting the interfolding of two of the webs of the folded sheet material product of FIG. 1 from two parallel feeds of such folded sheet material product to create an interfolded web product; and

FIG. 5 is a perspective view of the folded roll product of FIG. 1 folded in a “Z” type pattern to create a napkin, wipe, or the like folded product.

### DETAILED DESCRIPTION OF THE PREFERRED EMBODIMENTS OF THE INVENTION

The invention disclosed herein is, of course, susceptible of embodiment in many different forms. Shown in the drawings and described herein below in detail is a preferred embodiment of the folded roll product of the invention. It is to be understood, however, that the present disclosure is an exemplification of the principles of the invention and does not limit the invention to the illustrated embodiment.

It is also understood that the FIGURES herein do not necessarily show details of the folded sheet roll product or the parts of the apparatus for making or interfolding such folded sheet roll product that are known in the art and that will be recognized by those skilled in the art as such. The detailed descriptions of such elements are not necessary to an understanding of the invention. Accordingly, such elements are herein represented only to the degree necessary to aid in an understanding of the features of the present invention.

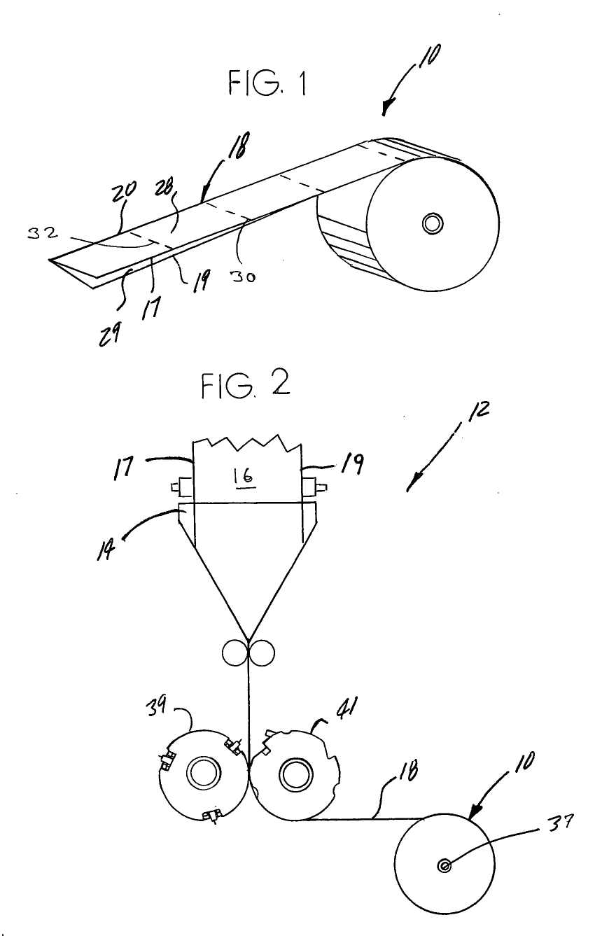

FIG. 1 depicts a finished roll 10 of dispensable folded sheet material 18 embodying the present invention. Sheet material 18 has a longitudinal fold 20 along one edge thereof and opposed side edges 17 and 19. Lines of perforation 30 and 32 delineate contiguous folded sheet material segments 28 and 29.

As shown schematically in FIG. 2, the production apparatus 12 includes a folding board 14 to which is fed, from a supply roll (not shown), a continuous elongate flat sheet of web material 16 such as, for example, paper or the like having spaced-apart longitudinally extending side edges 17 and 19. To fold the sheet 16 into any one of the several fold configurations depicted in FIG. 3, additional folding boards are utilized in parallel, in series, or both, as desired. As shown in FIG. 1, the folding board 14 is configured to create a folded sheet of web material 18 including at least one longitudinally extending fold line 20 and two opposed longitudinally extending sheet segments 28 and 29. Segment 28 has been folded about the fold line 20 so as to overlie segment 29, and the longitudinally extending side edge 17 of the sheet 18 is aligned with side edge 19.

The product of the present invention is characterized in that the folded web of sheet material 18, once it has passed through the folding board 14, is not immediately forwarded to an interfolder apparatus as currently known in the art but rather is rolled usually onto an accumulator roll core or cylinder 37 to create the roll 10 of the folded sheet material 18.

A double “C” folded sheet product 118 of FIG. 3(a) includes four separate appropriately positioned longitudinally extending fold lines 120, 122, 124 and 126 generated by four folding boards in parallel relationship to one another. Six separate, appropriately positioned folded longitudinal sheet segments 128, 130, 132, 134, 136 and 138 are produced in this manner.

The “Z” fold of FIG. 3(b), the single “C” fold of FIG. 3(c), the “V” fold of FIG. 3(d), the “fan” fold of FIG. 3(e) and the “M” fold of FIG. 3(f) are all similarly produced variations of the fold of FIG. 1 and incorporate one or more longitudinally extending fold lines and one or more folds made about such respective longitudinally extending fold lines.

To introduce perforations in the folded web, a pair of cooperating perforating rolls 39 and 41 are positioned at a location between the folding board 14 and the accumulator roll or cylinder 37. As the folded web of sheet material 18 travels from the folding board 14 through and between the respective perforating cylinders 39 and 41, perforation lines are introduced and extend in a spaced-apart and parallel relationship to one another but in a direction generally transverse to the longitudinally extending fold line 20.

Interfolding of the folded sheet material is illustrated in FIG. 4. Parallel folding boards 14 and 34 receive respective webs 16 and 36 and fold them longitudinally to produce respective folded sheet materials 18 and 38. Folded sheet material 18 is then passed, in turn, through feed rollers 23 and 24 to perforating rolls 39 and 41 and then into the nip of folding rolls 46 and 48. In a similar manner, folded sheet material 38 is passed through feed rollers 33 and 34 to perforating rolls 42 and 44 and from there into the nip of folding rolls 46 and 48. An interfolded product 50 exits from the nip of folding rolls 46 and 48.

In a like manner, segments of folded sheet material can be clean cut utilizing rolls 39 and 41 as well as rolls 42 and 44 as knife rolls in a known manner.

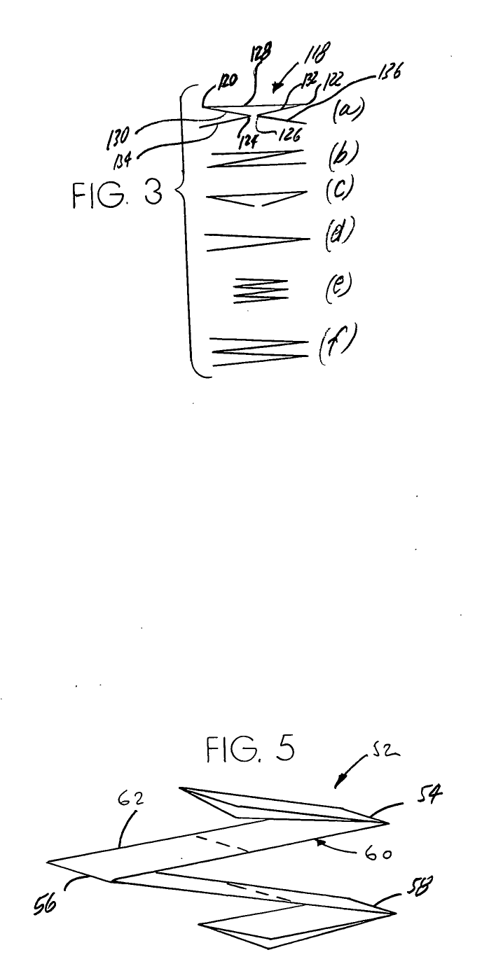

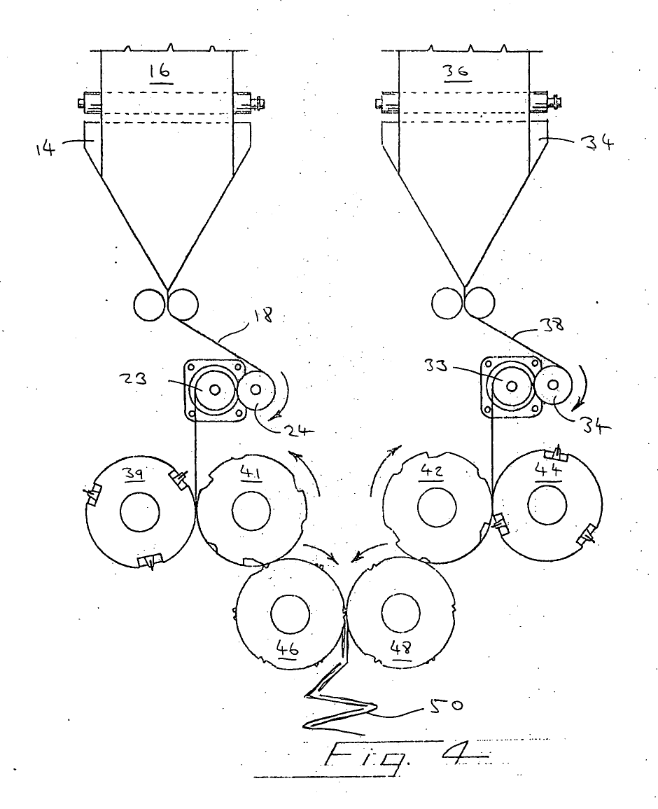

A generally Z-shaped product such as a perforated stack 52 of napkins, wipers or the like is illustrated in FIG. 5. Stack 52 includes three spaced-apart folds 54, 56 and 58, each extending across the width of folded sheet 60 in a direction transverse to the longitudinal fold 62.

It will be readily apparent from the foregoing detailed description of the invention and from the illustrations thereof that numerous variations and modifications may be effected without departing from the true spirit and scope of the novel concepts or principles of this invention.

1. A roll of dispensable material wherein the material comprises an elongate continuous sheet including at least one longitudinally extending fold line and at least one fold made about the longitudinally extending fold line.

2. The roll of claim 1 wherein the sheet includes a plurality of longitudinally extending fold lines and a plurality of folds together defining a sheet incorporating a double “c” shaped fold.

3. The roll of claim 1 wherein the sheet includes a plurality of longitudinally extending fold lines and a plurality of folds together defining a sheet incorporating a “z” shaped fold.

4. The roll of claim 1 wherein the sheet includes a plurality of longitudinally extending fold lines and a plurality of folds together defining a sheet incorporating a “v” shaped fold.

5. The roll of claim 1 wherein the sheet includes a plurality of longitudinally extending fold lines and a plurality of folds together defining a sheet incorporating a fan shaped fold.

6. The roll of claim 1 wherein the sheet includes a plurality of longitudinally extending fold lines and a plurality of folds together defining an “M” shaped fold.

7. The roll of claim 1 wherein the sheet includes a plurality of spaced-apart perforation lines extending in a direction transverse to the longitudinally extending fold line.

8. An apparatus for folding and winding an elongate sheet of material comprising:
a) a folding board through which the elongate sheet of material is fed and wherein at least one longitudinally extending fold line and at least one fold are formed; and
b) an accumulator roll downstream of the board onto which the sheet of material is wound in its folded orientation.

9. The apparatus of claim 8 further comprising a perforator located between the folding board and the accumulator roll for forming a plurality of spaced-apart transversely extending perforation lines in the elongate sheet of material.

10. The apparatus of claim 8 wherein the sheet includes a plurality of longitudinally extending fold lines and a plurality of folds made about the plurality of longitudinal extending fold lines respectively.

11. An apparatus for interfolding at least two sheets of material for forming a web of interfolded sheets of material, the apparatus comprising:
a) at least two dispensers containing at least two rolls of sheet material respectively wherein the sheets of material include at least one longitudinally extending fold line and at least one fold respectively; and
b) an interfolder through which the sheet material from each of the rolls is fed and for interfolding the respective sheets of material together for forming the web of the interfolded sheets of material.

12. The apparatus of claim 11 wherein the sheets of material respectively include a plurality of longitudinally extending fold lines and a plurality of folds together defining sheets of material incorporating a double “c” shaped fold.

13. The apparatus of claim 11 wherein the sheets of material respectively include a plurality of spaced-apart transversely extending perforation lines.
